(19) United States
(12) Patent Application Publication
(10) Pub. No.: US 2015/0315531 A1
(43) Pub. Date: Nov. 5, 2015

(54) NON-FLAMMABLE TERNARY COMPOSITIONS AND USE OF THESE COMPOSITIONS

(71) Applicant: SOLVAY SA, Bruxelles (BE)

(72) Inventors: Ercan UENVEREN, Hannover (DE); Helge RAU, Burgdorf (DE)

(21) Appl. No.: 14/653,529

(22) PCT Filed: Dec. 20, 2013
(86) PCT No.: PCT/EP2013/077835

§ 371 Date: Jun. 18, 2015

(30) Foreign Application Priority Data
Dec. 21, 2012 (EP) 12199170.7
Mar. 11, 2013 (EP) 13158510.1

(51) Int. Cl. C11D 7/50

(52) U.S. Cl. CPC C11D 7/5018; C11D 7/5063

(57) ABSTRACT

Non-flammable ternary compositions and use of these compositions. The invention relates to certain non-flammable compositions containing, 1,1,3,3-pentafluorobutane (R365mfc), 1,2-dichloroethylene and a hydrofluoroether, to mixtures containing these compositions and to the use of these non-flammable compositions or these mixtures, especially as precision cleaning agents for solid surfaces and for flushing, especially of refrigeration systems.

This application claims priority to European application No. 12199170.7 filed 21 Dec. 2012 and European application No. 13158510.1 filed 11 Mar. 2013, the whole content of these applications being incorporated herein by reference for all purposes.

The invention relates to certain ternary non-flammable compositions comprising 1,1,1,3,3-pentafluorobutane (R365mfc), 1,2-dichloroethylene and a hydrofluoroether, preferably the hydrofluoroether is selected from ethoxynonafluorobutane (HFE-7200) and methoxynonafluorobutane (HFE-7100), to mixtures comprising these non-flammable compositions and to their use, especially as cleaning and/or drying agents for solid surfaces and for flushing, especially of refrigeration systems.

Fully halogenated chlorofluorinated hydrocarbons (CFCs), in particular 1,1,2-trichloro-1,2,2-trifluoroethane (CFC-113), were widely used as solvents in industry for degreasing and cleaning various surfaces. In addition to their use in electronics in cleaning soldering, they were also conventionally used for degreasing metal components or for cleaning mechanical components of high quality and of high precision. In these various applications, CFC-113 was most often used in combination with other organic solvents, preferably in the form of azeotropic or pseudo-azeotropic compositions. For example, CFC-113 was used in combination with trans-1,2-dichloroethylene in compositions formerly known as Freon® MCA and Freon® SMT. Such compositions could also be used as cleaning agents in the refrigeration industry.

However, CFC-113, as well as other fully halogenated chlorofluoroalkanes, was suspected of being involved in the destruction of the stratospheric ozone layer. Consequently, compositions with reportedly lower ozone-layer destruction potential were disclosed in WO 2000/56833 and include compositions of 1,1,1,3,3-pentafluorobutane and 1,1,1,2,3,4,4,5,5,5-decafluoropentane or nonafluoromethoxybutane with the optional addition of trans-1,2-dichloruethylene (tDCE), npropyl bromide (nPB), acetone, methanol, ethanol or isopropanol.

In applications where the potential of fire is of concern, it is desirable for the cleaning compositions to be non flammable in both liquid and vapour phase, during usage. Accordingly, one of the objectives of the present invention is to provide non-flammable compositions.

During usage and/or when discharged to the atmosphere, a composition of a mixture may change, what might cause the composition remaining or the composition being discharged to become flammable or to exhibit unacceptable performance. Accordingly, it is another objective of this invention to provide compositions forming azeotropes or pseudo-azeotropes.

The HFCs that have been proposed as replacement for CFCs might have not sufficient solvency for electronics soils such as hydrocarbon or silicon oils and flux residues, or soils of the refrigeration industry. Accordingly, it is yet another object of the present invention to provide HFC-based cleaning compositions that exhibit acceptable solubility for electronics soils notably suited for cleaning printed circuit boards and/or soils in the refrigeration industry, notably as flushing agents for cleaning air conditioning systems.

Additionally, it is an objective of the present invention to provide compositions with a low global warming potential (GWP) and/or with a low ozone-depletion potential.

There is still a need in the electronics and refrigeration industry for compositions that provide advantageous compositions with regard to the aforementioned problems.

The compositions of the present invention solve one or more of at least the aforementioned problems confronting the cleaning and refrigeration industries.

Consequently, the present invention relates to non-flammable compositions consisting or consisting essentially of 1,1,1,3,3-pentafluorobutane (R365mfc) in a concentration of 5-20 wt %, 1,2-dichloroethylene in a concentration of 40-89 wt %, and a hydrofluoroether, preferably selected from ethoxynonafluorobutane (HFE-7200) and methoxynonafluorobutane (HFE-7100), in a concentration of 1-40 wt %, preferably 1,1,1,3,3-pentafluorobutane (R365mfc) in a concentration of 10-15 wt %, 1,2-dichloroethylene in a concentration of 65-85 wt %, and a hydrofluoroether, preferably selected from ethoxynonafluorobutane (HFE-7200) and methoxynonafluorobutane (HFE-7100), in a concentration of 5-20 wt %, more preferably 1,1,1,3,3-pentafluorobutane (R365mfc) in a concentration of 10-15 wt %, 1,2-dichloroethylene in a concentration of 70-80 wt %, and a hydrofluoroether, preferably selected from ethoxynonafluorobutane (HFE-7200) and methoxynonafluorobutane (HFE-7100), in a concentration of 10-15 wt %, and even more preferably 1,1,1,3,3-pentafluorobutane (R365mfc) in a concentration of 12-13 wt %, 1,2-dichloroethylene in a concentration of 74-76 wt %, and a hydrofluoroether, preferably selected from ethoxynonafluorobutane (HFE-7200) and methoxynonafluorobutane (HFE-7100), in a concentration of 12-13 wt %. Unless specified otherwise, the weight percentages in the present specification are all relative to the total weight of the composition.

The term “flammable” is meant to denote any flammability determined according to any applicable standard, and is preferably as defined in DIN/EN/ISO 13736.

The term “consisting essentially of” as used herein is intended to denote a composition comprising the components as specified as well as other components in trace amounts wherein the presence of the other components does not change the essential characteristics of the specified subject matter.

HFE-7200is commercially available from 3M and consists of the two isomers (CF₃)₂CFCF₂OC₂H₅ (CAS No. 163702-06-5) and CF₃CF₂CF₂CF₂OC₂H₅ (CAS No. 15 163702-05-4). HFE-7100is also commercially available from 3M.

1,2-Dichloroethylene exists in two isomeric forms, cis-1,2-dichloroethylene and trans-1,2-dichloroethylene. For the purposes of the present invention, 1,2-dichloroethylene is understood to mean, without distinction, one or the other isomer or a mixture of these. In a preferred embodiment, the 1,2-dichloroethylene consists essentially of trans-1,2-dichloroethylene.

In another preferred embodiment, the compositions of the present invention are azeotropic or pseudo-azeotropic. An azeotrope as used herein is a specific system containing at least two components in which, at a given temperature and a given pressure, the composition in the liquid phase is equal to the composition in the vapour phase. A pseudo-azeotrope as used herein is a specific system containing at least two components in which, at a given temperature and a given pressure, the composition in the liquid phase is substantially equal to the composition in the vapour phase. In practice, their composition remains substantially constant in solvent cleaning operations, as well as in operations for recovering spent solvents by distillation.

In another preferred embodiment, the non-flammable compositions have a GWP of <500, preferably <350, more preferably <250, most preferably <150. The Global Warming Potential (GWP) as used herein is determined using the 100-yr ITH, IPCC2001 method.

The invention also relates to mixtures comprising the inventive non-flammable compositions as described above and further comprising at least one stabilizer and/or at least one propellant.

The stabilizer can be present in an amount of up to or equal to 5 wt %, preferably up to or equal to 2%, more preferably up to or equal to 0.5 wt % relative to the total weight of the mixture. The stabilizer is intended to stabilize the components of the composition against undesired side reactions during storage, transportation or use. Examples of suitable stabilizers are epoxides, unsaturated hydrocarbons, nitroalkanes, diketones, brominated compounds, and alcohols. A preferred stabilizer is isopropanol.

The propellant assists in the delivery of the composition to the point of use. Representative propellants comprise air, nitrogen, carbon dioxide, difluoromethane, trifluoromethane, fluorinated ethanes, especially 1,1-difluoroethane, 1,1,1-trifluoroethane, 1,1,2-trifluoroethane, 1,1,1,2-tetrafluoroethane, 1,1,2,2-tetrafluoroethane, and pentafluoroethane. The propellant may be included in the composition in an amount of >0, preferably equal to or more than 5 parts, more preferably equal to or more than 10 parts by weight per 100 parts by weight of the composition according to the invention. Preferably, the amount of the propellant is equal to or less than 40 parts, preferably equal to or less than 30 parts by weight per 100 parts by weight of composition according to the invention.

Mixtures wherein the propellant is comprised in an amount of 1 to 25 parts per 100 parts of the composition according to the invention are especially suitable for flushing.

The compositions according to the invention can be used in the same applications and according to the same techniques as the prior compositions based on CFC-113.

The compositions can be used, for example, as cleaning agents in general, especially as surface cleaning agent, e.g. for cleaning parts, for example, precision parts, made of plastics or inorganic material. The term “cleaning” includes, for example, cleaning textiles, degreasing in general, for example, degreasing animal hides, surface cleaning, for example cleaning, especially degreasing of metal, glass, or ceramics parts; for example, cleaning of optical lenses, cleaning of electronic devices, e.g. printed circuit boards contaminated by a pickling flux and residues from this flux, or cleaning solid chemicals insoluble in the composition. Solid objects can be desiccated to remove the water adsorbed at the surface of solid objects.

Accordingly, the present invention also relates to method of use of the non-flammable compositions or the mixtures as described above as cleaning agents, preferably as precision cleaning agents, or as degreasing agents. Preferably, non-flammable composition or the mixture is in the vapour phase during the cleaning. Especially preferred is a method of use as a cleaning agent or as a degreasing agent for printed circuit boards contaminated by a pickling flux and residues from this flux or as desiccating agent for removing water adsorbed at the surface of solid objects. Alternatively, they also can be used as mold-release agents or for defluxing electronic components and for degreasing metals.

Preferably, the propellant-containing mixtures are used for flushing of refrigeration equipment. The interior surface of compression refrigeration equipment, for example, used for climatisation of rooms, space for storing goods, or automobiles (mobile air conditioning, MAC) sometimes needs cleaning from residues, for example, when the refrigerant has to be changed, or had evaporated because of a leakage or has to be removed for repair. The residue be located in lines or other parts of the apparatus, e.g. in the compressor. The residue comprises refrigerant, compressor lubricant, e.g. mineral oil, naphthenes or polyol ethers, metal particles or rust. By contact with the composition according to the present invention, the inner surface of the equipment is recovered substantially free of residue. The way of contacting is not critical. The composition preferably is flushed in liquid phase through the equipment. The vapour pressure of the propellant moves the composition through the equipment.

Accordingly, the present invention also relates to a method of use of the non-flammable compositions as described above and preferably the mixtures as described above for cleaning of interior surfaces of refrigeration equipment, especially by flushing the refrigeration equipment. More preferably the refrigeration equipment is an air-conditioner.

The non-flammable compositions and the mixture of the present invention can even can be applied as blowing agents for preparing plastic foams or for spraying liquids or as refrigerants.

The compositions, with or without a propellant, can be prepared in a very simple manner by mixing the constituents. Constituents which are gaseous at ambient pressure and temperature can be added in liquid form under pressure or by adding them to the other constituents under condensation.

The invention advantageously provides compositions which are non-flammable, despite a content of 1,2-dichloroethylene which per se is flammable. Unexpectedly, even compositions comprising R365mfc and 1,2-dichloroethylene and flammable stabilizers, for example, isopropanol, are non-flammable even though these compounds might have a flash point.

The examples below, without implied limitation, illustrate the invention in a more detailed way.

### EXAMPLES

### Example 1

Preparation of a Ternary Composition

Trans-1,2-dichoroethylene is mixed with 1,1,1,3,3-pentafluorobutane and ethoxynonafluorobutane (HFE-7200) in a weight ratio of 70:15:15. Flammability test with the composition of example 1:

The flammability test is performed according to DIN/EN/ISO 13736 in a closed cup of 75 ml inner volume. The cup also comprises a stirrer and a probe to determine the temperature of the liquid to be tested, and means to rise the temperature. In the lid of the cup, a device is contained which allows to direct a test flame to the surface of the liquid the combustibility of which has to be determined. The apparatus used had a thermo detector which responds to fast rise of the measured temperature (indicating that a flame occurred).

The stirrer rotated slowly (about 30 rpm). The liquid in the cup is slowly warmed up. Whenever the temperature rose by 0.5° C., the test flame is ignited and it was checked if the thermo sensor responded. The tested composition is non-flammable.

### Example 2

Use of the Composition of Example/for Vapour Degreasing

Metal parts can be greased on the surface to protect them against corrosion. Adhering grease can also be caused by the application of drawing wax, drawing grease or drawing oil during shaping the metal parts. The step of cleaning high-precision metal parts is performed in a vapour degreaser.

A vapour immersion unit which has two solvent-filled sumps can be applied. A boil cleaning tank comprises a solvent mixture which, additional to a higher-boiling solvent component additionally comprises the non-flammable composition described above. A rinsing tank only comprises the non-flammable composition described above.

The metal parts are assembled in a basket and immersed into the boil cleaning tank to dissolve adhering grease. They are then removed and immersed into the rinsing tank wherein adhering solvent mixture from the boil cleaning tank is rinsed. The parts then are covered with the lower-boiling composition of the rinsing tank. The basket is then removed from the rinsing tank and kept in the gas space above tanks. The solvent adhering on the surface of the metal parts passes into the vapour phase. Near the top of the vapour degreaser are three sets of cooled coils where the vapour condenses before it can escape from the unit. The condensed vapour flows back to a clean condensate tank and can be reused. A part of the vapour is fed to a drying unit to remove water from it. The degreased dry metal parts can then be removed from the vapour degreaser.

### Example 3

Preparation of a Mixture Comprising a Stabilizer and a Propellant

15 wt % 1,1,1,3,3-pentafluorobutane (R365mfc), 70 wt % 1,2-trans-dichloroethylene which comprises about 0.5 wt % isopropanol as stabilizer, and 15 wt % ethoxynonafluorobutane (HFE-7200) are mixed. This basic composition is filled into a container, and 10 parts 1,1,1,2-tetrafluoroethane are condensed into the container.

### Example 4

Flushing MAC Apparatus Using the Composition of the Present Invention

The mixture of example 3 is applied in a method for flushing a mobile air conditioning apparatus.

The refrigerant is removed beforehand. A storage tank containing the composition is connected to the apparatus, and respective valves are opened. The composition is flushed through the lines and parts of the apparatus including the compressor. Residual oil and solids are removed during the treatment. The composition after leaving the apparatus is collected in a tank and can be conditioned for reuse by distillation. The flushed apparatus is clean and degreased and can be refilled with refrigerating agent.

1. A non-flammable composition consisting or consisting essentially of
(a) 1,1,1,3,3-pentafluorobutane (R365mfc) in a concentration of 10-15 wt %,
(b) 1,2-dichloroethylene in a concentration of 65-85 wt %, and
(c) a hydrofluoroether in a concentration of 5-20 wt %.

2. The non-flammable composition of claim 1 consisting or consisting essentially of
(a) 1,1,1,3,3-pentafluorobutane (R365mfc) in a concentration of 10-15 wt %,
(b) 1,2-dichloroethylene in a concentration of 70-80 wt %, and
(c) a hydrofluoroether in a concentration of 10-15 wt %.

3. The non-flammable composition of claim 2 consisting or consisting essentially of
(a) 1,1,1,3,3-pentafluorobutane (R365mfc) in a concentration of 12-13 wt %,
(b) 1,2-dichloroethylene in a concentration of 74-76 wt %, and
(c) a hydrofluoroether in a concentration of 12-13 wt %.

4. The non-flammable composition of claim 1 wherein the 1,2-dichloroethylene consists essentially of trans-1,2-dichloroethylene.

5. The non-flammable composition of claim 1 wherein the composition is azeotropic.

6. The non-flammable composition of claim 1 wherein the composition is pseudo-azeotropic.

7. The non-flammable composition of claim 1 wherein the composition has a GWP of <500.

8. The non-flammable composition of claim 1 wherein the hydrofluoroether is ethoxynonafluorobutane (HFE-7200).

9. The non-flammable composition of claim 1 wherein the hydrofluoroether is methoxynonafluorobutane (HFE-7100).

10. A mixture comprising the non-flammable composition of claim 1 and at least one stabilizer and/or at least one propellant.

11. The mixture of claim 10 wherein the mixture comprises at least one stabilizer wherein the stabilizer is isopropanol.

12. A cleaning agent, or degreasing agent comprising the non-flammable composition of claim 1.

13. The cleaning agent or degreasing agent of claim 12, wherein the non-flammable composition is in the vapor phase.

14. A method for removing water adsorbed at the surface of solid objects comprising using the cleaning agent or degreasing agent of claim 12 as desiccating agent.

15. A method for cleaning of interior surfaces of refrigeration equipment, the method comprising contacting the interior surfaces of the refrigeration equipment with the mixture of claim 16.

16. The mixture of claim 10 wherein the mixture comprises at least one propellant.

17. The method of claim 15, wherein contacting the interior surfaces of the refrigeration equipment comprises flushing the refrigeration equipment.
